(19) United States
(12) Patent Application Publication
(10) Pub. No.: US 2013/0030568 A1
(43) Pub. Date: Jan. 31, 2013

(54) ROBOT SYSTEM CONTROL METHOD AND A DEVICE THEREFOR

(71) Applicants: Tae Jin Park, Daejeon (KR); Jae Hoon Kim, Daejeon (KR); Young Youl Ha, Seoul (KR); Sang Dong Park, Daejeon (KR); Sung Min Yoon, Daejeon (KR); Min Su Kim, Daejeon (KR)

(72) Inventors: Tae Jin Park, Daejeon (KR); Jae Hoon Kim, Daejeon (KR); Young Youl Ha, Seoul (KR); Sang Dong Park, Daejeon (KR); Sung Min Yoon, Daejeon (KR); Min Su Kim, Daejeon (KR)

(73) Assignee: Samsung Heavy Ind. Co., Ltd., Seoul (KR)

(21) Appl. No.: 13/576,790

(22) PCT Filed: Apr. 23, 2010
(86) PCT No.: PCT/KR2010/002587

§ 371 Date: Aug. 2, 2012

(51) Int. Cl. B25J 9/16

(52) U.S. Cl. 700/245

(57) ABSTRACT

The present invention discloses a method of controlling a robot system and an apparatus thereof. The method of controlling a robot system in accordance with an embodiment of the present invention can include: initializing the master controller by use of a boot loader equipped in the robot system; executing a runtime by loading a runtime execution code stored in a storage space of the master controller; and loading and executing an application program stored in the storage space of the master controller. With an embodiment of the present invention, it becomes possible to manage the application program more efficiently for realizing the functions of the robot system.

### TECHNICAL FIELD

The present invention relates to a method of controlling a robot system.

### BACKGROUND ART

Industrial robots often use embedded controllers for controlling their movement and motion. The conventional embedded robot controllers generally adopt a simple boot loader method.

When a problem occurs in some of the application programs for controlling the robot in the simple boot loader method, it is not easy to solve the problem by rebooting only the application program having the problem. Therefore, such a problem has been solved by restarting the boot loader by rebooting the entire embedded controller, no matter how small the occurred error is.

Moreover, in the conventional boot loader system, it has been difficult to manage the process of each application program efficiently in an environment where multiple application programs are running.

Demanded, therefore, is development of a method and an apparatus for controlling a robot system that can manage multiple application programs efficiently and respond to an error quickly.

### DISCLOSURE

### Technical Problem

The present invention provides a method of managing an embedded robot system efficiently using a runtime system and an apparatus thereof.

### Technical Solution

An aspect of the present invention features an apparatus for controlling a robot system configured to control the robot system by use of a master controller embedded in the robot system. According to an embodiment of the present invention, the master controller can include: a runtime unit; a storage unit configured to store a runtime code for executing a runtime, a runtime symbol table, and an application code for carrying out designated functions of the robot system; an operation unit configured to carry out an operation for executing the runtime and control a flow of signals for control of the robot system; and a communication unit configured to communicate with a host computer of the robot system. The runtime unit can include: an application loader module configured to load the application code; and an application program interface module configured to execute the loaded application code.

The runtime unit can also include a controller shape management module configured to recognize a slave controller embedded in the robot system and dynamically manage a configuration of system information of the robot system.

The runtime unit can also include a data logger module configured to generate log data from operation of the runtime.

The application program interface module can execute the application code by use of a system call of an operating system of the robot system, and a parameter referenced for execution of the application code can be transferred using a registry of the apparatus for controlling a robot system.

Another aspect of the present invention features a method of controlling a robot system by use of a master controller embedded in the robot system. The method in accordance with an embodiment of the present invention can include: initializing the master controller by use of a boot loader equipped in the robot system; executing a runtime by loading a runtime execution code stored in a storage space of the master controller; and loading and executing an application program stored in the storage space of the master controller.

The method can also include, after executing the runtime, generating log data from operation of the master controller.

The robot system can also include a slave controller, and the method can also include, after executing the runtime, dynamically managing the slave controller and a configuration of system information.

In the step of loading and executing the application program, a system call of an operating system of the robot system can be used, and a parameter for execution of the application program can be transferred using a registry of the master controller.

Other aspects, features and advantages of the present invention will become better understood through the accompanying drawings, the claims and the detailed description.

### Advantageous Effects

According to some embodiments of the present invention, it becomes possible to improve the efficiency of managing application programs for realizing the functions of a robot system by implementing the runtime in the control of the robot system.

### DESCRIPTION OF DRAWINGS

FIG. 1 illustrates an environment in which a robot control system using a runtime is realized in accordance with an embodiment of the present invention.

FIG. 2 shows a configuration of a robot system control apparatus using a runtime in accordance with an embodiment of the present invention.

FIG. 3 shows a configuration of a controller runtime in accordance with an embodiment of the present invention.

FIG. 4 is a flow diagram showing a method of controlling a robot system using a runtime in accordance with an embodiment of the present invention.

FIG. 5 illustrates a runtime loading operation of a controller in accordance with an embodiment of the present invention.

FIG. 6 illustrates steps of loading an application program of the controller in accordance with an embodiment of the present invention.

FIG. 7 illustrates steps of running an application program of the controller in accordance with an embodiment of the present invention.

FIG. 8 shows a controller application host interface in accordance with an embodiment of the present invention.

FIG. 9 illustrates an operation of an application loader included in the controller runtime in accordance with an embodiment of the present invention.

FIG. 10 illustrates an application program interface of the controller runtime in accordance with an embodiment of the present invention.

### MODE FOR INVENTION

Hereinafter, a method of controlling a robot system using a runtime and an apparatus thereof in accordance with some embodiments of the present invention will be described in detail with reference to the accompanying drawings.

This, however, is by no means to restrict the present invention to certain embodiments, and it shall be appreciated that all permutations, equivalents and substitutes covered by the technical ideas and scopes of the present invention are included in the description. In describing the present invention, when certain detailed description of relevant known art is considered to evade the gist of the present invention, such detailed description will be omitted. Moreover, any identical or corresponding elements will be assigned with a same reference numeral, and no redundant description thereof will be provided.

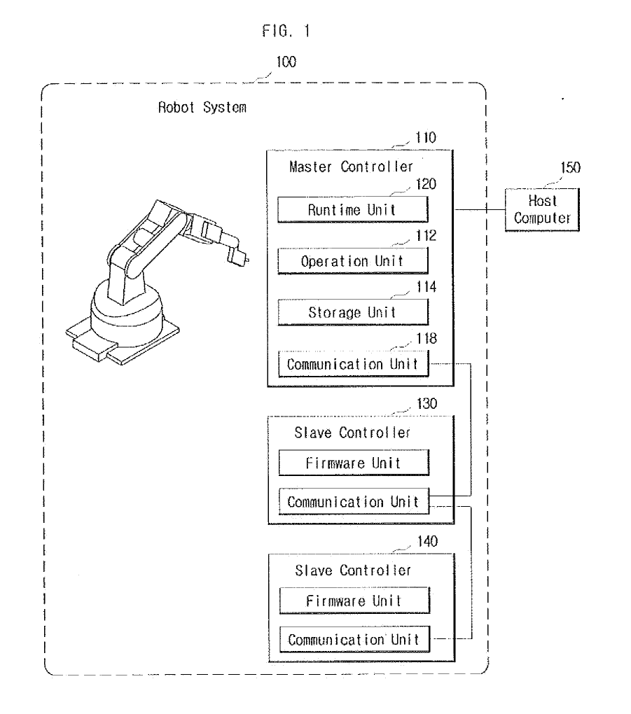

FIG. 1 illustrates an environment in which a robot control system using a runtime is realized in accordance with an embodiment of the present invention. Referring to FIG. 1, the robot system 100 can include a master controller 110, a runtime unit 120, a first slave controller 130 and a second slave controller 140. The master controller 110 can communicate with a host computer 150 to receive a user command.

The robot system 100 can include a plurality of manipulators, which can be controlled by the master controller 110 and/or the slave controllers 130, 140.

The master controller 110, which is a main controller of the robot system 100, can receive the user command from the host computer 150 and manage/control the slave controllers 130, 140 and/or the manipulators. The master controller in accordance with an embodiment of the present invention does not use a simple boot loader method but adopt the runtime unit 120 to improve the management efficiency of the robot system 100.

The slave controllers 130, 140 can include a firmware module, in which functions required for control operations of each slave driver are realized in the form of firmware. The slave controllers 130, 140 can be connected with the master controller 110 through a communication unit and managed by the master controller 110.

The host computer 150 is a terminal used by a user of the robot system 100 in order to control the robot system 100 and can be any of a variety of known terminals in addition to a computer. The user can access the runtime unit 120 of the master controller 110 through the host computer 150 to manage the robot system 100.

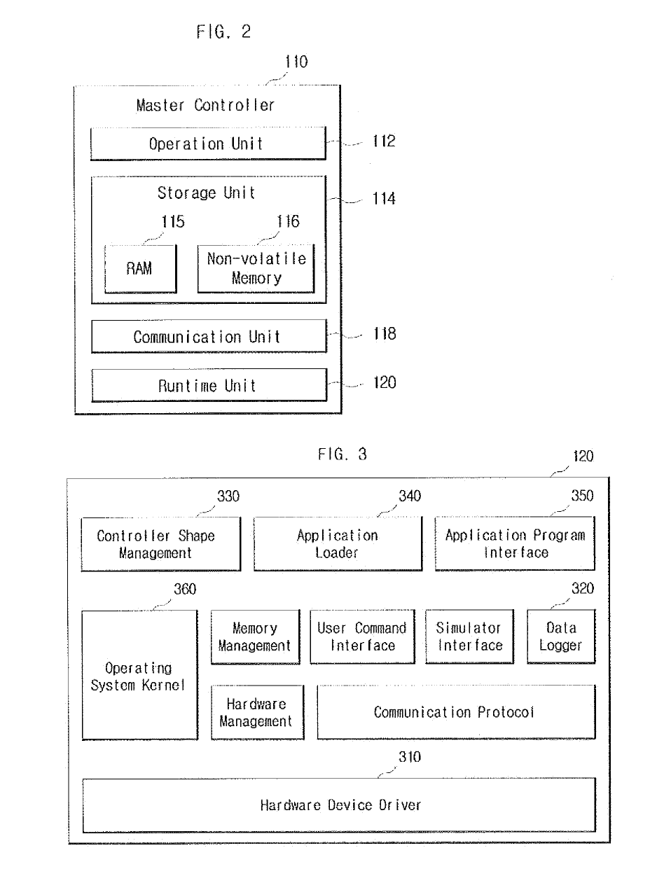

FIG. 2 shows a configuration of a robot system control apparatus using a runtime in accordance with an embodiment of the present invention. Referring to FIG. 2, the master controller 110 in accordance with an embodiment of the present invention can include an operation unit 112, a storage unit 114, a communication unit 118 and a runtime unit 120.

The operation unit 112, which corresponds to a central processing unit (CPU) of the master controller 110, can control the flow of signals within the master controller 110 and perform physical operations for functions carried out by the master controller 110. For example, the operation unit 112 in accordance with an embodiment of the present invention can perform an operation for executing a runtime by controlling the runtime unit 120 and control the flow of signals in the robot system control apparatus.

The storage unit 114, which is a space for storing data required for performing the functions of the master controller 110, can correspond to a memory chip in a master controller. Specifically, the storage unit 114 can store a runtime code for executing a runtime, a runtime symbol table, an application code for realizing the functions of the robot system, data required when an application is executed, and result data of executing the application. For example, the storage unit 114 of the master controller 110 in accordance with an embodiment of the present invention can be distinguished into a RAM 115 and a non-volatile memory 116.

The RAM 115 can carry out the function of storing information for operation of the master controller 110. The RAM 115 generally has a faster response speed than the non-volatile memory 116 and initializes its contents when power is cut off. The RAM 115 can store a variety of data according to the state in which the robot system 100 is maneuvered.

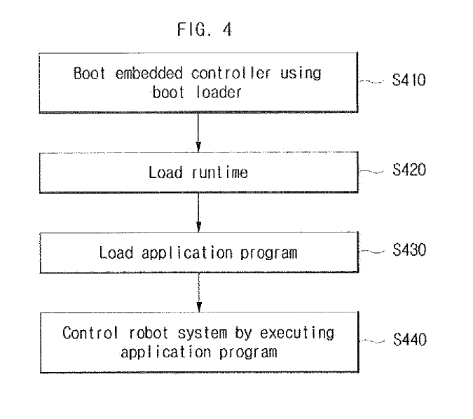

The non-volatile memory 116, which maintains its contents even when power is cut off, can be realized in a flash memory and the like. The non-volatile memory 116 can store a runtime code, a runtime symbol table, an application code for realizing the functions of the robot system, and application data resulted from executing an application. Data stored in the storage unit 114 according to operation steps of the robot system 100 will be described later in detail with reference to FIGS. 4 to 7.

The communication unit 118 can communicate with the host computer of the robot system 100. That is, the communication unit 118 can handle transfer of signals between the master controller 110 and the host computer 150. In addition, the communication unit 118 can handle communication between the master controller 110 and another component of the robot system 100, for example, the slave controller, the manipulator and the like. The transfer of signals for the control of the robot system 100 can be realized with various means, such as TCP socket communication, UDP communication, TFTP communication, etc., and the communication unit 118 can correspond to networking hardware handling such communication means,

Configurations of other required hardware that constitute the master controller 110 are well known to those who are ordinarily skilled in the art to which the present invention pertains, and thus detailed description thereof will be omitted. Operations of the master controller 110 for the control of the robot system 100 and the configuration of the runtime unit 120 will be described in detail with reference to other drawings.

FIG. 3 shows a configuration of the runtime unit 120 of the master controller 110 in accordance with an embodiment of the present invention. Referring to FIG. 3, functions that can be carried out by the runtime unit 120 in accordance with an embodiment of the present invention are illustrated in blocks. However, what is illustrated is only for the convenience of description and understanding, and it shall be appreciated that the functions can be variously sub-divided or combined with 2 or more other functions in the configuration of the runtime unit 120.

The runtime unit 120 in accordance with an embodiment of the present invention can include one or more of a hardware device driver module 310, a hardware management module, a memory management module, a communication protocol module, a user command interface module, a simulator interface module, a data logger module 320, a controller shape management module 330, an application loader module 340, an application program interface module 350 and an operating system kernel 360.

The controller shape management module 330 can recognize the slave controller embedded in the robot system and dynamically manage the configuration of system information.

The operating system kernel 360 can manage the components according to their functions, like a kernel of a common operating system.

The hardware device driver module 310 can support a driver for driving hardware components of the master controller 110. Accordingly, the components of the runtime unit 120 utilize hardware resources through the hardware device driver module 310, and information on use of hardware can be managed through a hardware management function and a memory management function.

The data logger module 320 can collect and record log data for operations of the master controller 110 controlling the robot system 100 and the slave controllers 130, 140. Such control log data can be sent to the host computer 150. The data logger module 320 can exchange information with the host computer through, for example, TCP/IP socket communication.

The application loader module 340 can provide a symbol table loading function and an application program loading function for realizing the functions of the robot system 100.

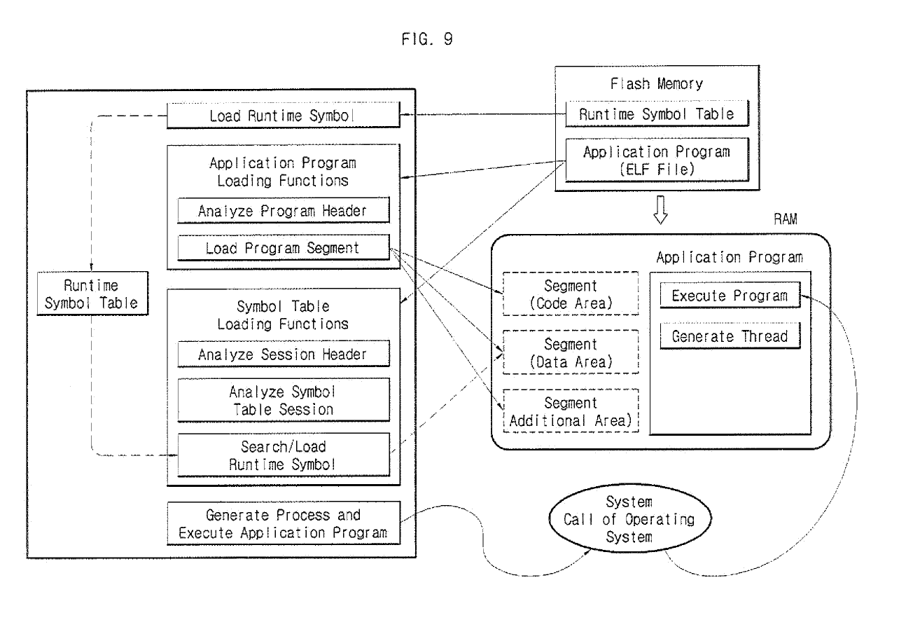

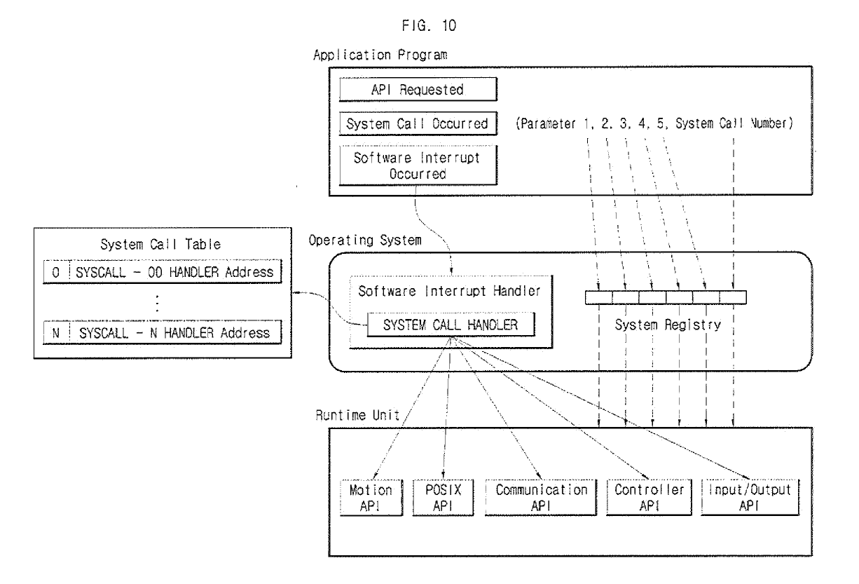

Here, the application loader module 340 can provide a function of loading a data value of a symbol table, which is specifically prepared by the user, in an application program executed by the application program interface module 350. Moreover, the application program executed through an application program loader can call and use the functions of a runtime through an application program interface of the runtime. Detailed operations of the application loader module 340 will be described with reference to FIG. 9.

The application program interface module 350 can execute an application code by use of a system call of an operating system of the robot system 100. Moreover, a parameter referred to by the execution of the application code can be transferred using a registry of a device controlling the robot system. In other words, the application program interface module 350 is a module that supports API supporting the execution of an application program by use of a system call provided by the operating system of the robot system. Calling and executing an application program interface will be described with reference to FIG. 10.

The user command interface module can provide a function of receiving a user command from the host computer 150 and responding to the host computer 150 with a result of carrying out he user command. The simulator interface module can provide an interface with robot simulation software installed on the host computer 150.

In the runtime unit 120 of the master controller 110 in accordance with an embodiment of the present invention, a universal asynchronous receiver/transmitter WART), Ethernet, IP (Internet Protocol), ARP (Address Resolution Protocol), TCP (Transmission Control Protocol), UDP (User Datagram Protocol), TFTP (Trivial File Transfer Protocol) and the like can support a communication protocol.

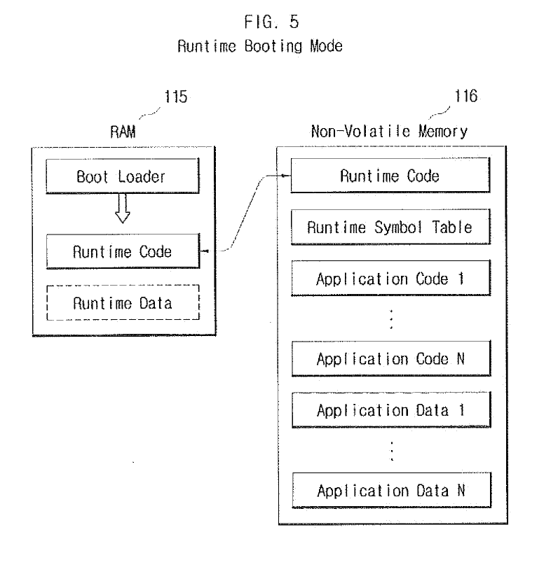

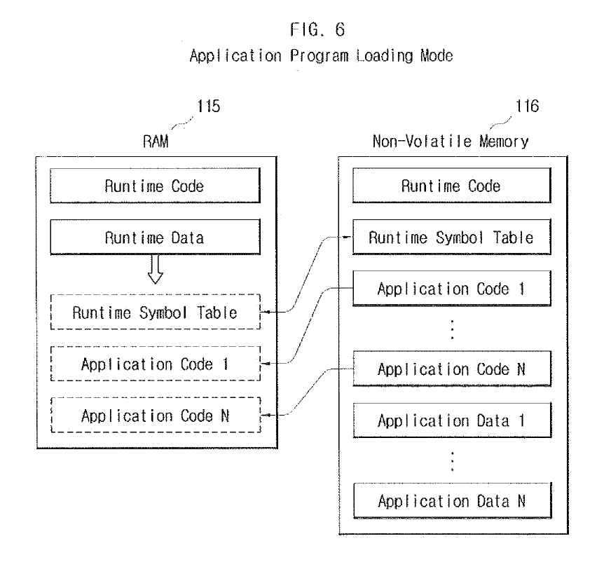

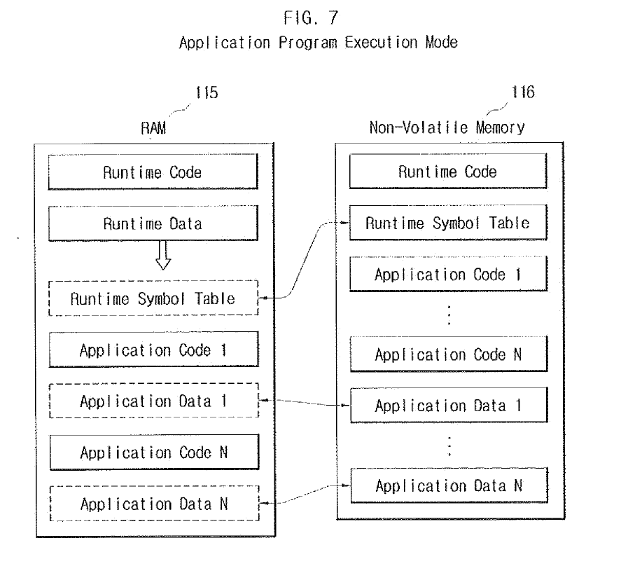

FIG. 4 is a flow diagram showing a method of controlling a robot system in accordance with an embodiment of the present invention. FIG. 5 illustrates a runtime loading operation of a controller in accordance with an embodiment of the present invention. FIG. 6 illustrates steps of loading an application program of the controller in accordance with an embodiment of the present invention. FIG. 7 illustrates steps of running an application program of the controller in accordance with an embodiment of the present invention.

In the step of booting an embedded controller by use of a boot loader (S410), the master controller 110 is initialized using the boot loader. That is, in this step, the master controller 110 and/or the slave controllers 130, 140 are initialized for control of the robot system 100. Through this initializing procedure, a runtime can be ready for loading in the master controller 110. Initializing the robot system by the boot loader is well known to those of ordinary skill in the art and thus will not be described hereinafter.

In the step of loading a runtime (S420), after the initializing the robot system 100 by the boot loader is completed, starting of the runtime unit 120 is prepared. Referring to FIG. 5, the runtime loading step can be carried out by loading a runtime code to the RAM 115 from the non-volatile memory 116 of the master controller 110. Once the master controller 110 is initialized and booted by the boot loader, the boot loader can load a runtime execution code, which is stored in the non-volatile memory 116, in the RAM 115. Once the runtime execution code is loaded from the flash memory by the boot loader, the boot loader hands over a control right of the controller and executes the runtime. In other words, in this step, the runtime unit 120 is executed by loading the runtime execution code in the memory of the master controller 110. Once the runtime is executed, runtime data can be generated according to initialization information that is programmed in the runtime execution code.

In the step of loading an application program (S430), an application program of the robot system is loaded using the application loader module 340 of the runtime unit 120. That is, the application program for realizing the functions of the robot system is loaded while the runtime unit 120 of the master controller 110 is executed. Referring to FIG. 6, loading of the application program can be carried out by loading the runtime symbol table and the application program (application code 1, application code N) in the RAM 115. The user of the host computer 150 can correct the runtime symbol table through the runtime unit 120.

In the step of executing the application program (S440), the application program is executed using the application program interface module 350 of the runtime unit 120. That is, the functions of the robot system 100 are realized by executing the loaded application program. Here, the application program interface module 350 uses the system call of the operating system of the robot system 100, and a parameter for executing the application program can be transferred using a registry of the master controller 110. Once loading of the application code is completed, the runtime unit 120 dynamically generates a process and executes the application code. Here, the application code can generate application data according to the initialization information and, if necessary, refer to the runtime symbol table to correct the application data. Each application program can be generated and managed as a separate process by the operating system. As such, the runtime unit 120 of the master controller 110 can load and execute a number of application programs simultaneously.

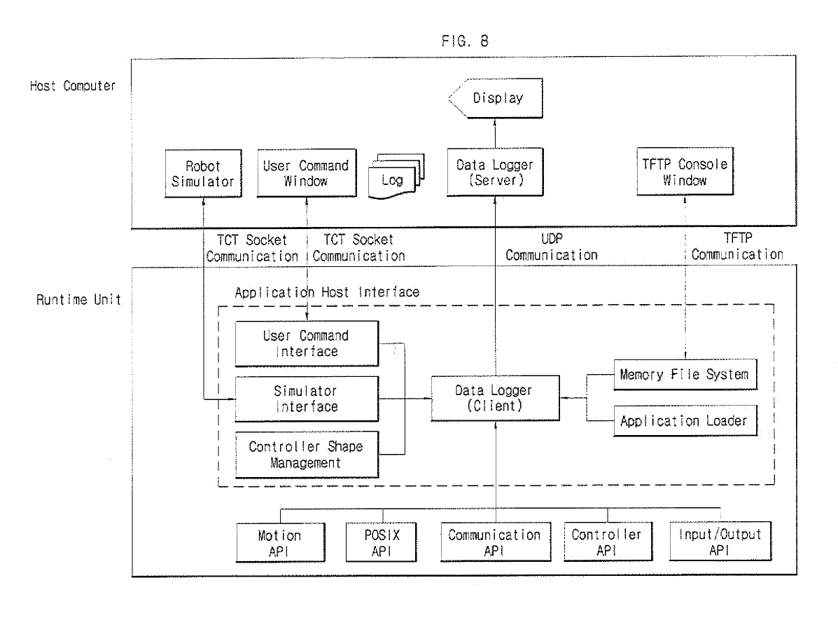

FIG. 8 shows a controller application host interface in accordance with an embodiment of the present invention.

As described above, the runtime unit 120 of the master controller 110 can exchange information with the host computer 150 through an application-host interface. As illustrated in FIG. 8, the application-host interface can include a user command interface module, a simulator interface module, the controller shape management module 330, a memory file system module and the application loader module 340.

The user command interface module can exchange data with the host computer through TCP socket communication, When the user inputs a robot control command through a user command window of the host computer 150, the user command interface module of the application-host interface of the master controller 110 can receive and execute the robot control command and reply with the result of execution in the user command window.

The simulator interface module can exchange data with a robot simulator' of the host computer through TCP socket communication.

The memory file system module can be connected with a TFTP console window of the host computer through TFTP communication, The user can download or upload a file from and to the master controller 110 and change and/or delete a file neme, through a TFTP command.

Operations of the above-mentioned user command interface module, simulator interface module, controller shape management module 330, memory file system module, application loader module 340 and application program interface module 350 can be monitored by a data logger client. The monitored information can be sent to a data logger server of the host computer 150 through UDP socket communication.

FIG. 9 illustrates an operation of the application loader included in the controller runtime in accordance with an embodiment of the present invention.

As described above, the application loader module 340 can provide the application program loading function and the symbol table loading function. Here, the runtime symbol table can be configured by a user command or in a file form for storage in the flash memory. Moreover, the application program can be stored in the flash memory in an ELF (Executable and Linking Format) file form by an application program developer. The ELF file form of application program can include a code segment, a data segment and an additional segment of the program.

Once the application loader module 340 is executed, the runtime symbol table can be loaded. Once the runtime symbol is loaded, each program segment can be extracted by analyzing a program header from the ELF file, and the extracted program segment can be loaded to the RAM 115. When the loading of the application program is completed, the application loader module 340 can search the already-loaded runtime symbol table to find symbol data matching the symbol data of the application program and load the matched symbol data in a data area of the application program.

Once the application program and the symbol table are loaded, the runtime unit 120 can call a system call of the operating system in order to generate a new application process and execute the application program. After the application program is assigned with a new process from the operating system and executed, the application program can generate and execute a separate thread in the program.

FIG. 10 illustrates the application program interface of the controller runtime in accordance with an embodiment of the present invention.

The application program interface module 350 provided by the runtime unit 120 of the master controller 110 can include a motion API, POSIX API, a communication API, a controller API and an input/output API. Various application programs for realizing the functions of the robot system 100 can be executed by calling the application program interface (API) of the runtime unit 120 through a system call provided by the operating system.

A parameter transferred with a request for API and a system call number corresponding to the called API can be copied in the system registry of the master controller 110. Once a system call is made by calling the API in the application program, a software interrupt can occur so that the operating system can receive and process the system call.

Once the software interrupt is occurred by the application program, a system call hander in a software interrupt handler of the operating system calls and executes the requested API by referring to a handler address (API address) of the pertinent system call registered in the system call table of the operating system. Here, the requested API can be processed by receiving an API request parameter stored in the system registry of the master controller 110. Once the API is called and executed through the software interrupt and the system call, an execution result can be returned to the application program by the software interrupt handler.

Hitherto, for the convenience of description and understanding of the present invention, a certain embodiment of the present invention has been described. However, it shall be appreciated that permutations of the present invention are possible without departing from the essential features of the present invention by those who are ordinarily skilled in the art to which the present invention pertains. Therefore, the disclosed embodiment shall be understood in descriptive perspectives, not restrictive perspectives. The scope of the present invention shall be defined by the appended claims, rather than by the above description, and all differences within the equivalent scope shall be understood to be included in the present invention.

1. An apparatus for controlling a robot system configured to control the robot system by use of a master controller embedded in the robot system, wherein the master controller comprises:
a runtime unit;
a storage unit configured to store a runtime code for executing a runtime, a runtime symbol table, and an application code for carrying out designated functions of the robot system;
an operation unit configured to carry out an operation for executing the runtime and control a flow of signals for control of the robot system; and
a communication unit configured to communicate with a host computer of the robot system, and
wherein the runtime unit comprises:
an application loader module configured to load the application code; and
an application program interface module configured to execute the loaded application code.

2. The apparatus of claim 1, wherein the runtime unit further comprises a controller shape management module configured to recognize a slave controller embedded in the robot system and dynamically manage a configuration of system information of the robot system.

3. The apparatus of claim 1, wherein the runtime unit further comprises a data logger module configured to generate log data from operation of the runtime.

4. The apparatus of claim 1, wherein the application program interface module is configured to execute the application code by use of a system call of an operating system of the robot system, and a parameter referenced for execution of the application code is transferred using a registry of the apparatus for controlling a robot system.

5. A method of controlling a robot system by use of a master controller embedded in the robot system, the method comprising:
initializing the master controller by use of a boot loader equipped in the robot system;
executing a runtime by loading a runtime execution code stored in a storage space of the master controller; and
loading and executing an application program stored in the storage space of the master controller.

6. The method of claim 5, further comprising, after executing the runtime, generating log data from operation of the master controller.

7. The method of claim 5, wherein the robot system further comprises a slave controller, and
further comprising, after executing the runtime, dynamically managing the slave controller and a configuration of system information.

8. The method of claim 5, wherein in the step of loading and executing the application program, a system call of an operating system of the robot system is used, and a parameter for execution of the application program is transferred using a registry of the master controller.
